(19) United States
(12) Patent Application Publication
(10) Pub. No.: US 2009/0257615 A1
(43) Pub. Date: Oct. 15, 2009

(54) Headwear

(76) Inventor: Lawrence J. Bayer, JR., Emerald Isle, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 12/082,880

(22) Filed: Apr. 15, 2008

(51) Int. Cl. H04R 25/00

(52) U.S. Cl. 381/376

(57) ABSTRACT

A combination headwear having ear-covering sections and a headphone assembly having a speaker for each ear attached to a curved band that conforms to the top portion of a human head, and an integrated antenna module configured to receive satellite digital audio radio signals. The headwear includes openings sized for the speakers such that the speakers can be inserted between the ear-covering sections and the ear canals of the wearer of the headwear. In this way, the antenna is external to the headwear and the ear-covering sections cover the user's ears and the headphone assembly's speakers.

### BACKGROUND OF THE INVENTION

(1) Field of Invention

The present invention relates to headwear adapted to accommodate the speakers of a headphone assembly. In particular, the invention relates to a combination headwear and headphone assembly with an integrated personal satellite radio receiver.

(2) Description of the Prior Art

It is presently possible to enjoy a personal satellite digital audio radio service (SDARS) during outdoor activities through the use of a portable headphone assembly. Typically, such a headphone assembly is comprised of a speaker for each ear attached to a curved band that conforms to the top portion of a human head, and an integrated antenna module configured to receive satellite digital audio radio signals.

The comfort of the user's ears with regard to temperature is not an issue during warm weather. However, such is not the case in cold weather. In a cold weather environment, the user will want to use a headwear along with the SDARS headphone assembly.

Headwear such as baseball style caps, and toboggan caps or hats are used to keep a wearer's head warm in cold temperatures. Headwear especially configured for extreme cold weather includes ear-covering sections that are specifically designed to keep the wearer's ears warm. Examples of such headwear include but are not limited to toboggan caps and hats with ear flaps. However, these types of headwear do not allow for the accommodation of a SDARS headphone assembly.

For example, when a person attempts to use a SDARS headphone assembly with headwear having ear-covering sections they will either have to pull the ear-covering sections of the headwear away from their ears in order to accommodate the speakers of the headphone assembly or they will try to use the headphone assembly under the headwear. Both scenarios present serious problems. If the ear-covering sections are pulled away from the wearer's ears he will lose the insulation value of the ear-covering sections and his ears will get cold. On the other hand, if the headwear is pulled over the headphone assembly, satellite-reception is greatly reduced or interrupted altogether. Therefore, what is needed is a combination headwear and satellite receiver headphone assembly that retains heat for keeping the user's ears warm and also provides excellent satellite reception.

### SUMMARY OF THE INVENTION

The present invention provides a combination headwear and satellite receiver headphone assembly that retains heat for keeping the user's ears warm and also provides excellent satellite radio reception. In general, the invention comprises a headwear made of a thermal insulating material that includes ear-covering sections and a headphone assembly with a radio receiver having an antenna integrated with a curved headband for positioning on a user's head, and speakers attached to the receiver for placement near the ear canals of the user's ears. In particular, the ear-covering sections of the headwear include openings sized for insertion of the speakers so that the speakers will be between the wearer's ears and the ear-covering sections of the headwear. In this way, the antenna is external to the headwear and the ear-covering sections completely cover the user's ears and the headphone assembly's speakers.

In particular, the present invention combines a headphone assembly having a speaker for each ear attached to a curved band that conforms to the top portion of a human head, and an integrated antenna/receiver module configured to receive satellite digital audio radio signals with a headwear having ear-covering sections. The invention can be realized with various types of headwear that include ear-covering sections. For example, a cap with ear flaps is a type of headwear that is useable with the present invention. In this case, openings such as slits are sized to accommodate the speakers of a given headphone assembly during manufacture of the cap. The required slits are formed just above the ear flaps that make up the cap's ear-covering sections.

Another example of the present invention is realized with hooded sweatshirts commonly referred to as hoodies. In this example, openings preferably in the form of slits are manufactured into the hood at locations that correspond with the top of a wearer's ears when the hood is properly donned over the wearer's head. The length of each slit is sized to accommodate the diameter of a given headphone assembly's speakers.

In yet another example, close-fitting knitted caps commonly referred to as toboggan caps, ski caps or stocking caps can also make up the headwear portion of the present invention. A family of these close-fitting knitted caps includes but is not limited to turned-up caps, in which the bottom of the cap rolls up over the wearer's ears when normally worn and non-turned up caps that are shorter in overall length, but still completely cover the wearer's ears. A special type of knitted cap in this family of caps is a full faced ski mask, which covers all portions of the wearer's head with the exception of the areas about the eyes.

In all of these cases, openings that are preferably slits are manufactured into the knitted caps at locations generally near the top of the ear when the knitted cap is properly worn (i.e., pulled over the wearer's head to just below the wearer's ears). The slits in the non-turned up caps would be externally visible, whereas the slits formed in turned up caps would be hidden.

It is preferred that the slits are releasably closable by opposing strips of hook and loop material attached to opposing walls of the openings within the headwear insulating material. The hook and loop material can be pressed together to provide a tight seal around the curved band holding the speakers once the speakers are inserted through the headwear slits. The fastened slit can be reopened by pulling the mated hook and loop material apart. Hook and loop material suitable for the present invention is commonly referred to as VELCRO™.

Yet another feature of the present invention is the addition of a layer of padding material to the top of the headwear. Preferably, the padding material is a strip having a length sized to go from the top of one ear to the other when the headwear is properly worn. It is also preferred that the strip of padding material is slightly wider than the width of the curved band attached to the speakers. The padding strip can be attached to the headwear during the headwear manufacture. Moreover, the padding strip can include a conductive mesh film that promotes satellite radio reception.

Still another feature of the present invention is an optional clasp or sleeve that secures the curved band of the headphone assembly to the headwear. The clasp or sleeve preferably attaches to the headwear and passes over both the padding strip and the curved band of the headphone assembly.

In operation, a user of the present invention passes the speakers of the headphone assembly through the openings above the headwear's ear-covering sections. Next, the user dons the headwear and adjusts the headphone assembly's curved band to position it directly over the headwear's padding strip. The optional clasp is then positioned by the user to retain the headphone assembly's curved band directly over the headwear's padding strip.

Other aspects of the invention will become apparent to one skilled in the art upon a reading of the following detailed description of the invention, taken with the drawings.

### BRIEF DESCRIPTION OF THE DRAWINGS

FIG. 1 is a perspective view of a headphone assembly making up the satellite radio receiver portion of the present invention.

FIG. 2 is a front view of an ear flap type of headwear making up a headwear portion of the present invention.

FIG. 3 depicts the combination of the headphone assembly of FIG. 1 and the headwear of FIG. 2 properly worn by a user.

FIG. 4 depicts the headphone assembly of FIG. 1 in combination with a knit cap headwear having exposed speaker openings.

FIG. 5 depicts the headphone assembly of FIG. 1 in combination with a knit cap having hidden speaker openings.

FIG. 6 depicts the headphone assembly of FIG. 1 in combination with a hooded sweatshirt having speaker openings.

FIG. 7 depicts the headphone assembly of FIG. 1 in combination with a helmet type headwear having speaker openings.

FIG. 8 is cross-sectional view of a headwear similar to that shown in FIG. 3 with the top cap section sliced away.

FIG. 9 depicts a headphone assembly in combination with the headwear cross-section of FIG. 8.

### DETAILED DESCRIPTION OF THE PREFERRED EMBODIMENT

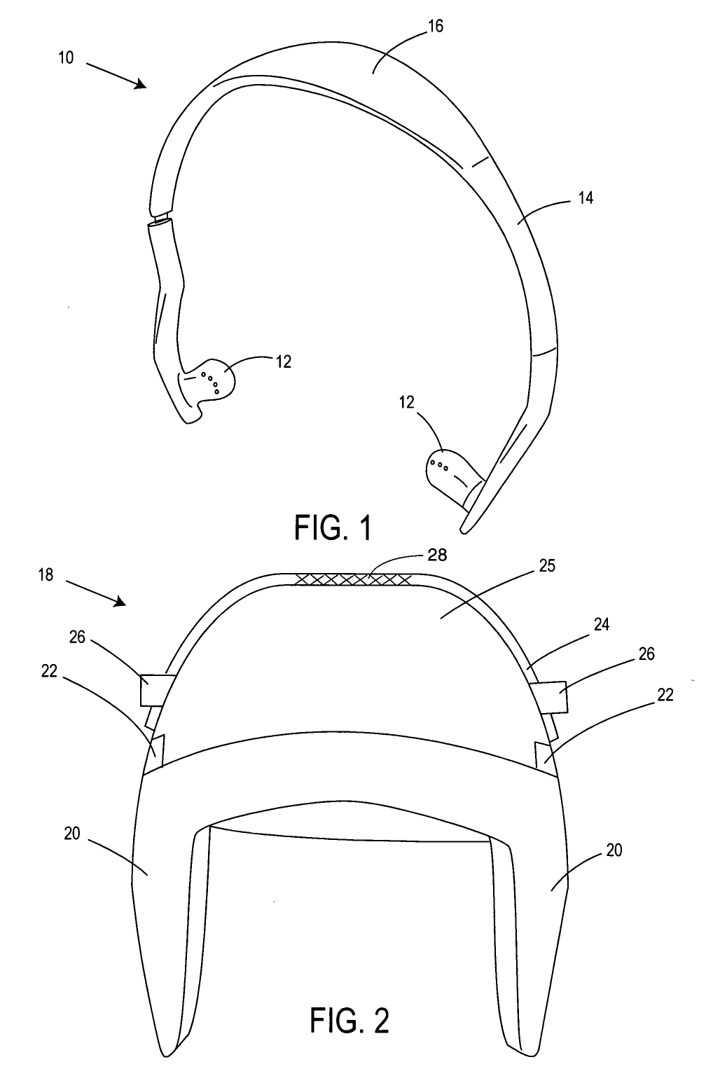

In the following description, like reference characters designate like or corresponding parts throughout the several views. It is to be understood that descriptive terms and the like are words of convenience and are not to be construed as limiting terms. Referring now to the drawings in general, and FIGS. 1 and 2 in particular, it will be understood that the illustrations are for the purpose of describing preferred embodiments of the invention and are not intended to limit the invention thereto.

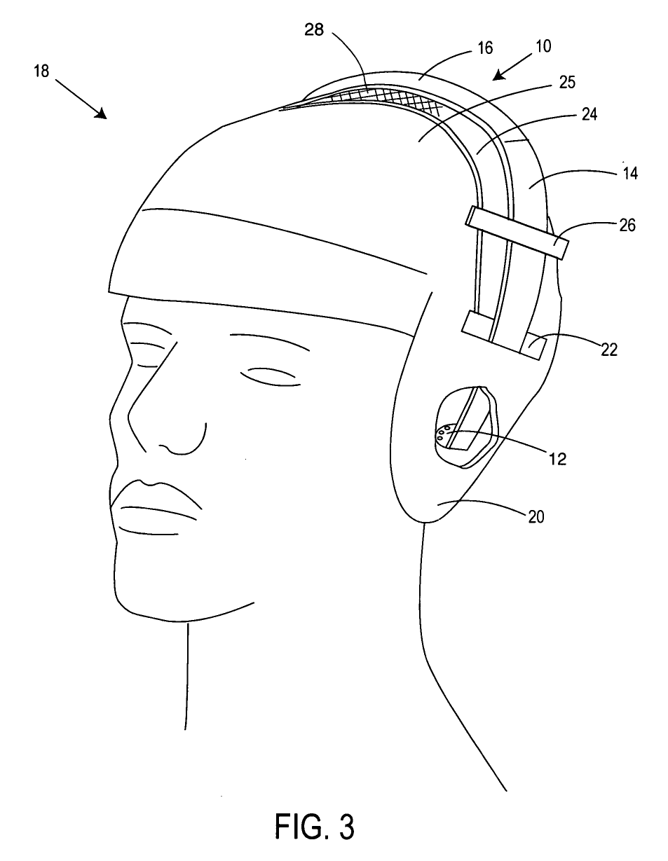

FIG. 1 depicts a headphone assembly, generally 10 having a speaker 12 for each ear attached to a curved band 14 that conforms to the top portion of a human head, and an integrated antenna/receiver module 16 configured to receive satellite digital audio radio signals. FIG. 2 depicts a headwear 18 having ear-covering sections 20. Openings 22 sized for insertions of speakers 12 are located just above ear-covering sections 20. A strip of padding material 24 is attached to the top section 25 of headwear 18. An optional clip or sleeve 26 is attachable to either side of headwear 18 for helping maintain the position of headphone assembly curved band 14 when the combination headwear and headphone assembly is properly worn as shown in FIG. 3. The position of speakers 12 relative to ear covering sections 20 is shown in the partial cut-away view of ear covering sections 20.

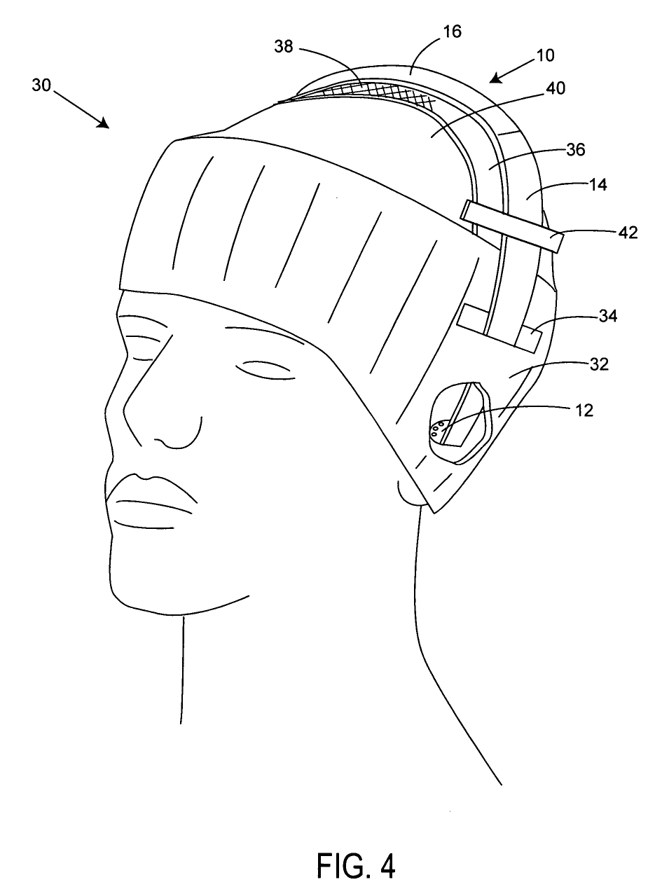

FIG. 4 depicts headphone assembly 10 in combination with a knit cap 30 having an ear covering section 32 for each ear. A slotted opening 34 in each ear covering section is for passing speakers 12 from external ear covering sections 32 to in between the ear covering sections 32 and the user's ears. Each of openings 34 is located at the top of a user's ear when headwear 30 is properly worn as shown in FIG. 4. Openings 34 in headwear 30 are visible when headwear 30 is properly worn as shown in FIG. 4. A padded strip 36 is attached to a top cap section 40 of the headwear 30. Padded strip 36 makes wearing headphone assembly 10 a more comfortable experience. Moreover, an optional conductive mesh 38 attached to padded strip 36 aids in the reception of satellite radio signals making the radio listening experience of the user more enjoyable. An optional clip 42 is attachable to either side of headwear 30 for helping maintain the position of headphone assembly curved band 14 when the combination of headwear 30 and headphone assembly 10 is properly worn as shown in FIG. 4. The position of speakers 12 relative to ear covering sections 32 is shown in the partial cut-away view of one of ear covering sections 32.

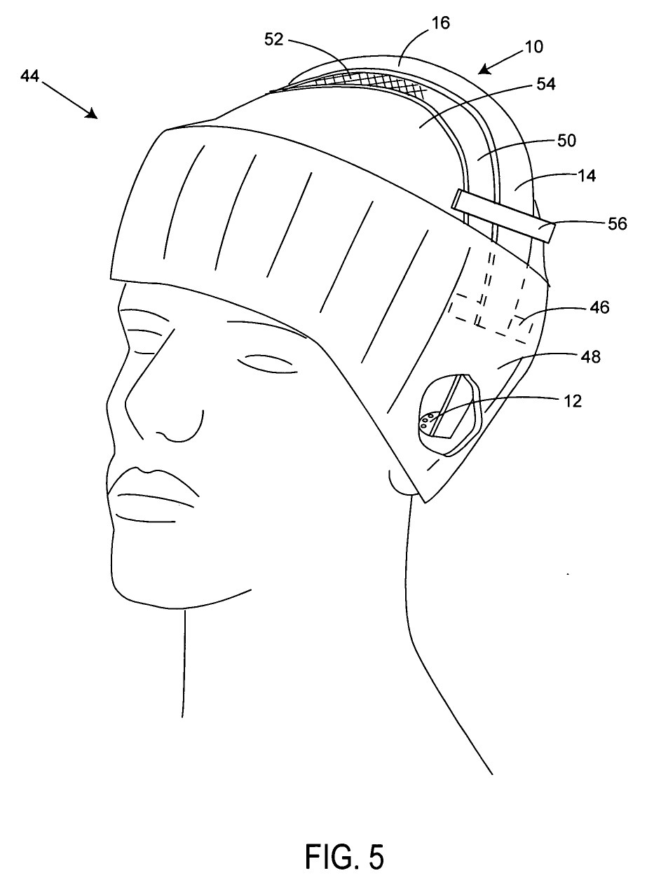

Another knit cap type headwear 44 shown in FIG. 5 is similar to headwear 30 of FIG. 4. However, instead of having externally visible openings, headwear 44 has a hidden opening 46 within each ear covering section 48. Each of openings 46 (shown in dashed lines) is located at the top of a user's ear when headwear 44 is properly worn as shown in FIG. 5. The position of speakers 12 relative to ear covering sections 48 is shown in the partial cut-away view of one of ear covering sections 48.

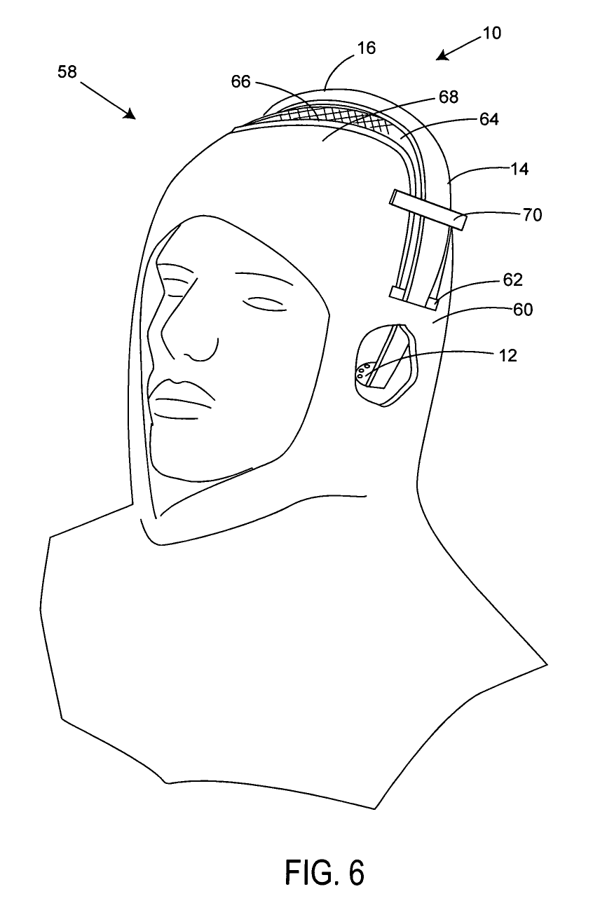

FIG. 6 shows another headwear in combination with headphone assembly 10. In this case, a headwear 58 is a hood attached to a sweatshirt. Headwear 58 has ear covering sections 60. An opening 62 is located in each ear covering sections 60 just above the user's ear when headwear 58 is properly worn as depicted in FIG. 6. An optional clip 70 is attachable to either side of headwear 58 for helping maintain the position of headphone assembly curved band 14 when the combination of headwear 58 and headphone assembly 10 is properly worn as shown in FIG. 6. The position of speakers 12 relative to ear covering sections 60 is shown in the partial cut-away view of one of ear covering sections 60.

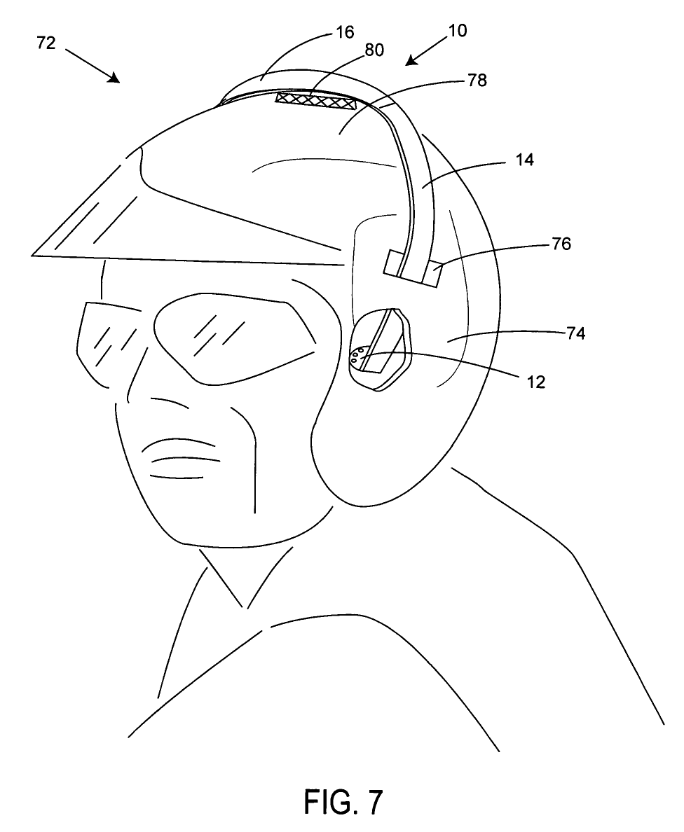

FIG. 7 shows yet another headwear in combination with headphone assembly 10. In this case, a headwear 72 is a helmet, such as a motorcycle or ski helmet. Ear covering sections 74 each include an opening 76, which are sized to pass speakers 12 from external of helmet 72 to inside ear covering sections 74 to adjacent the wearer's ear canals. Headphone assembly curved band 14 passes over a helmet crown section 78. Unlike the previous examples of headwear, there is no need for a padded strip. A conductive film 80 can be added to a crown section 78 to aid satellite radio reception. The position of speakers 12 relative to ear covering sections 74 is shown in the partial cut-away view of one of ear covering sections 74.

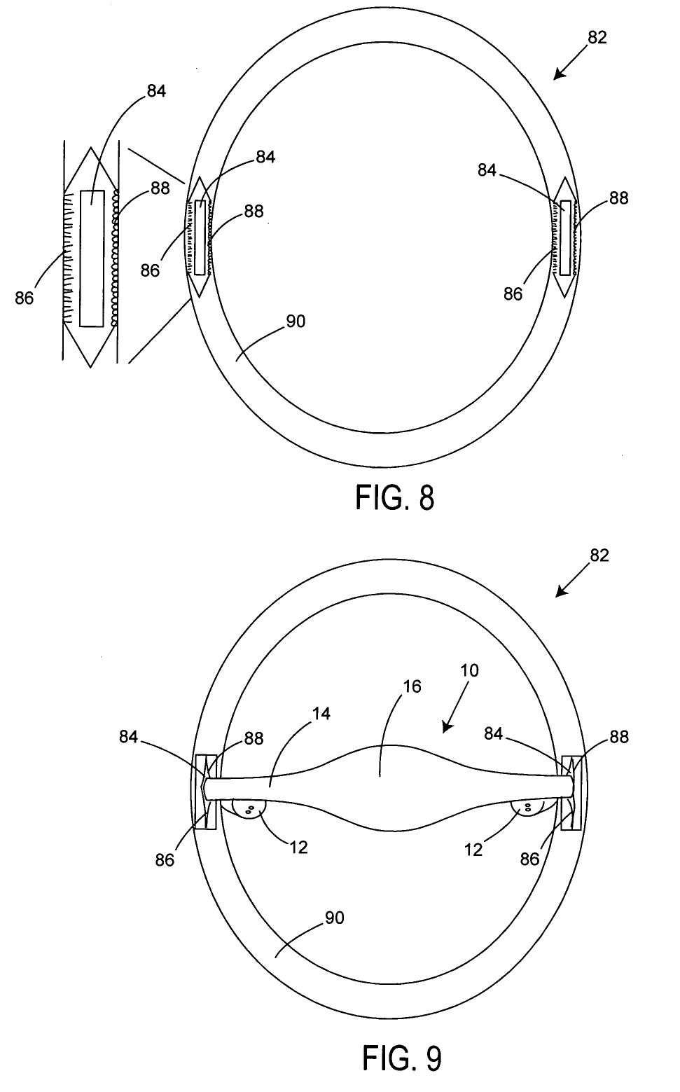

FIG. 8 is cross-sectional view of a headwear 82 similar to that shown in FIG. 3 with the top cap section sliced away. Openings 84 in the shape of slits are releasably closable by opposing strips of hook material 86 and loop material 88 attached to opposing walls of the openings within the headwear insulating material 90.

As shown in FIG. 9 hook material 86 and loop material 88 can be pressed together to provide a tight seal around headphone assembly 10's curved band 14 holding speakers 12 once speakers 12 are inserted through the headwear openings 84. Fastened openings 84 can be reopened by pulling the mated hook material 86 and loop material 88 apart. Hook and loop material suitable for the present invention is commonly referred to as VELCRO™.

Returning to FIGS. 1, 2 and 3, the operation of the present invention will be explained. In operation, a user of the present invention passes speakers 12 of the headphone assembly 10 through openings 22 above ear-covering sections 20. Next, the user dons headwear 18 and adjusts the headphone assembly's curved band 14 to position it directly over padding strip 24. The user then positions clasp 26 over curved band 14 and padding strip 24 in order to retain the headphone assembly 10 onto headwear 18.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. In combination, a headphone assembly having an antenna/receiver module and curved band for positioning on a user's head and speakers attached to said receiver for insertion in the user's ears, and a headwear made of an insulating material, said headwear having a top cap section and ear covering sections with openings in the ear covering sections sized for insertion of said speakers.

2. The combination of claim 1, wherein said ear covering sections' openings are releasably closable by opposing strips of hook and loop material attached to opposing walls of a slit within said headwear insulating material.

3. The combination of claim 1, further including a padded strip attached to said top cap section for providing a cushion for the receiver and antenna of said headphone assembly.

4. The combination of claim 3, wherein said padded strip further includes a conductive mesh for enhancing the signal reception of said antenna/receiver module.

5. The combination of claim 3, further including a clasp attached to said headwear for maintaining said curved band onto said padded strip.

6. The combination of claim 1, wherein said headwear is a cap that includes ear flaps.

7. The combination of claim 1, wherein said headwear is a knit cap and said speaker openings are externally visible.

8. The combination of claim 1, wherein said headwear is a knit cap and said speaker openings are hidden from view.

9. The combination of claim 1, wherein said headwear is the hood of a sweatshirt.

10. The combination of claim 1, wherein said headwear is a helmet.

11. A headwear made of an insulating material having a top cap section and ear covering sections and releasably closable openings sized to accommodate headphone speakers having a given diameter, said releasably closable openings being positionable above the ears of a user when said headwear is placed on the user's head such that said ear covering sections cover the user's ears.

12. The headwear of claim 11, wherein said ear covering sections' openings are releasably closable by opposing strips of hook and loop material attached to opposing walls of a slit within said headwear insulating material.

13. The headwear of claim 11, further including a padded strip attached to said top cap section for providing a cushion for the receiver and antenna of said headphone assembly.

14. The headwear of claim 13, wherein said padded strip further includes a conductive mesh for enhancing the signal reception of said antenna/receiver module.

15. The headwear of claim 13, further including a clasp attached to said headwear for maintaining said curved band onto said padded strip.

16. The headwear of claim 11, further includes ear flaps.

17. The headwear of claim 11, wherein said speaker openings are externally visible.

18. The headwear of claim 11, wherein said speaker openings are hidden from view.

19. The headwear of claim 11, wherein said headwear is the hood of a sweatshirt.

20. The headwear of claim 11, wherein said headwear is a helmet.
